(19) United States
(12) Patent Application Publication
(10) Pub. No.: US 2008/0028475 A1
(43) Pub. Date: Jan. 31, 2008

(54) Method For Authenticating A Website

(76) Inventor: Erez Kalman, Kfar Saba (IL)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/720,247

(22) PCT Filed: Nov. 24, 2005
(86) PCT No.: PCT/IL05/01254

§ 371 Date: Oct. 16, 2007

(30) Foreign Application Priority Data
Nov. 25, 2004 (IL) 165405

(51) Int. Cl. G06F 7/04

(52) U.S. Cl. 726/28

(57) ABSTRACT

The present invention relates to a method for the authentication of a website, the method comprises: (a) establishing an agreement between a user and a website owner where the user receives at least one personal client key and the website owner receives at least one personal authenticating website code; (b) performing initial access to the website by the user; (c) performing, by the website, challenge of the user for his client key; (d) submitting, by the user, his client key and sending to the website; (e) verifying at the website said client key; (f) sending by the website to the user the said agreed personal authenticating website code associated with that user; and (g) verifying by the user that this is indeed the authentic website code as agreed between him and the website owner.

### FIELD OF THE INVENTION

The present invention relates to the field of Internet authentication techniques. More particularly, the invention relates to a method for authenticating a website.

### BACKGROUND OF THE INVENTION

In the world today many business transactions are done through the Internet, whether by shopping on-line in websites offering goods and merchandise or by paying bills through a designated website. Furthermore many banks allow their customers to perform money transactions through the bank website which is claimed to be secured. All websites involved in money transactions need some kind of authentication from the customer before approving the transaction as to prevent an impostor to pose as a customer. An electronic request issued from one network unit to another for authentication will be referred to hereinafter as a challenge, while the authenticating or answer to the request will be referred to hereinafter as a response. Some of the authentication techniques involve using a password known by the user and authenticated by the website, which can be used alone or together with a username. Furthermore some of the authentication techniques use two passwords together with a username, or a password together with a credit card number or an ID number or even a key which is installed in a hardware device. The common factor of all the authentication techniques above is the use of input fields supplied by the user (response) on demand of the website (request) for authenticating the user. Therefore many ways have been devised by hackers and internet thieves to copy and steal these input fields, due to the fact that these input fields or passwords are the keys for authentication. Once acquiring the means for authentication, a hacker is able to buy or transfer money using the account of the user.

One of the tricks used by computer hackers to copy passwords to bank websites, where the bank is interested in allowing his customers to utilize money transactions, involves impersonation. The computer hacker buys an internet address similar to an address of a bank, or changes the IP numbers corresponding to a certain address to mislead the user into a different website than the one he intended to access, and sets a faked website similar to the real website of the bank. Once a user of the bank enters the hacker site, he is led to think that he has entered the correct site of the bank and then he is requested to enter his password and personal details while the system records his input. Furthermore, the hacker might wait for the user to enter the correct website of the bank and then open another website page on the user's computer, hiding the open bank website, requesting the password while recoding the input. At the critical moment, for example, after entering the password, the user is notified of a failure with the Internet connection misleading the user to believe that his password is still safe. After acquiring the password and username of a user, the hacker has the confidential details of the user, and he can log into the real website of the bank and can enter the theft username and password of the private bank account. Once in a private bank account the hacker can do essentially everything the user is entitled to in the website, such as transfer money from the account or use the personal information for other uses.

US publication 2004/0139152 suggests a system in which a user issues a first request at a website and the website issues a challenge to the user. The challenge maybe selected among a number of different types of challenges, and the user has to file an appropriate response. This publication solves some of the problems concerning the authentication of the user but does not offer a solution to the problem of authenticating the website for the user and determining that the website is truly what it claims to be.

It is an object of the present invention to provide a system which is capable of authenticating a public website for the user.

It is another object of the present invention to provide a public website authentication system that is easy to use by an average user.

It is still another object of the present invention to provide a public website authentication system that cannot be copied easily and automatically by a computer program.

Other objects and advantages of the invention will become apparent as the description proceeds.

### SUMMARY OF THE INVENTION

The present invention relates to a method for authentication of a website, the method comprises: (a) establishing an agreement between a user and a website owner where the user receives at least one personal client key and the website owner receives at least one personal authenticating website code; (b) performing initial access to the website by the user; (c) performing, by the website, challenge of the user for his client key; (d) submitting, by the user, his client key and sending to the website; (e) verifying at the website said client key; (f) sending by the website to the user the said agreed personal authenticating website code associated with that user; and (g) verifying by the user that this is indeed the authentic website code as agreed between him and the website owner.

Preferably the method further comprises: (h) further establishing in said agreement between user and website owner second personal client key; (i) challenging, by the website, the user for said second client key, after sending said authenticating website code; and (j) submitting said second client key by user to the website.

Preferably the user first client key is a username.

Preferably the authenticating website code is a picture.

Preferably the authenticating website code is a hardware indication.

Preferably the authenticating website code is a personal question.

Preferably the challenging for a second client key is a request to reply to the authenticating website code.

Preferably the request for the second client key is a request for password.

Preferably the second client key is a password.

Preferably there is another request for a password after the request to reply to the personal code.

Preferably the first client key and/or second client key of the user are submitted automatically by the user side with or without human intervention.

### BRIEF DESCRIPTION OF THE DRAWINGS

In the drawings:

FIG. 1 is a flow chart generally illustrating the method of the invention.

FIG. 2 is a flow chart generally illustrating an embodiment of the invention.

### DETAILED DESCRIPTION OF PREFERRED EMBODIMENTS

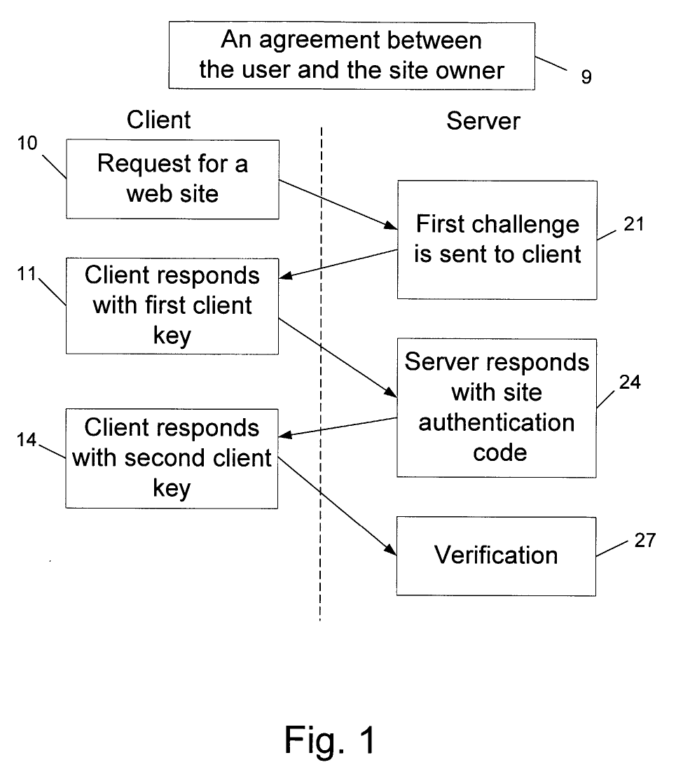

FIG. 1 is a flow chart generally illustrating the method for authenticating a website that handles money transactions, according to an embodiment of the present invention. In block 9, a pre-agreement takes place between the user and the site owner concerning the manner by which the user is authenticated toward the website and the manner by which the website is authenticated toward the user. The user is given at least two personal keys, generally, one for identification and one for verification, whereas the site owner receives one code from the user for authentication. The user's first key for identification, referred to hereinafter as the first client key, may be a username, the website code referred to hereinafter as site authentication code may be a personal picture, and the user's second key for verification, referred to hereinafter as second client key, may be a secret password.

In block 10 the user (or “client”), requests the display of the website by typing the website address. In block 21 the website, referred to hereinafter also as “server”, responds and sends a challenge to the client requesting him to identify himself. In block 11, the client responds by entering his first client key. In block 24 the server receives the first client key identifying the client, compares this key with its users database, and responds by sending to the client the site authentication code, associated with that specific client. In block 14 the client receives the site authentication code, and only after recognizing that the code is authentic, the client responds by entering and sending the second client key (his password). In block 27 the server receives the second client key, and verifies its authenticity. Only if the client second key is found to be authentic, the client is allowed to access the website.

It should be noted that in a different embodiment the method may be carried out with only one client key as described in the following third example.

In a first example, a pre-agreement takes place between the user and the site owner. The user is given at least two personal keys, a username and a secret password, whereas the site owner receives one code for authentication, for example, a picture from the user. The client requests display of the website by typing the website address. The server responds and sends a challenge to the client requesting the first user key, i.e., a username. The client responds by entering the username. The server receives the username identifying the client, compares the username with its users database, and responds by sending to the client the site authentication code, the pre-agreed picture, associated with that specific client. The client receives the picture, and only after recognizing that the picture is indeed the pictured agreed upon, the client responds by entering and sending the second client key, his secret password. The server receives the password, and verifies its authenticity. Only if the client password is found to be authentic, the client is allowed to access the website. In such a manner, the client knows the website is authentic, as only the authentic website possesses the personal site code for that user, and the site knows that the user is authentic by verifying his password.

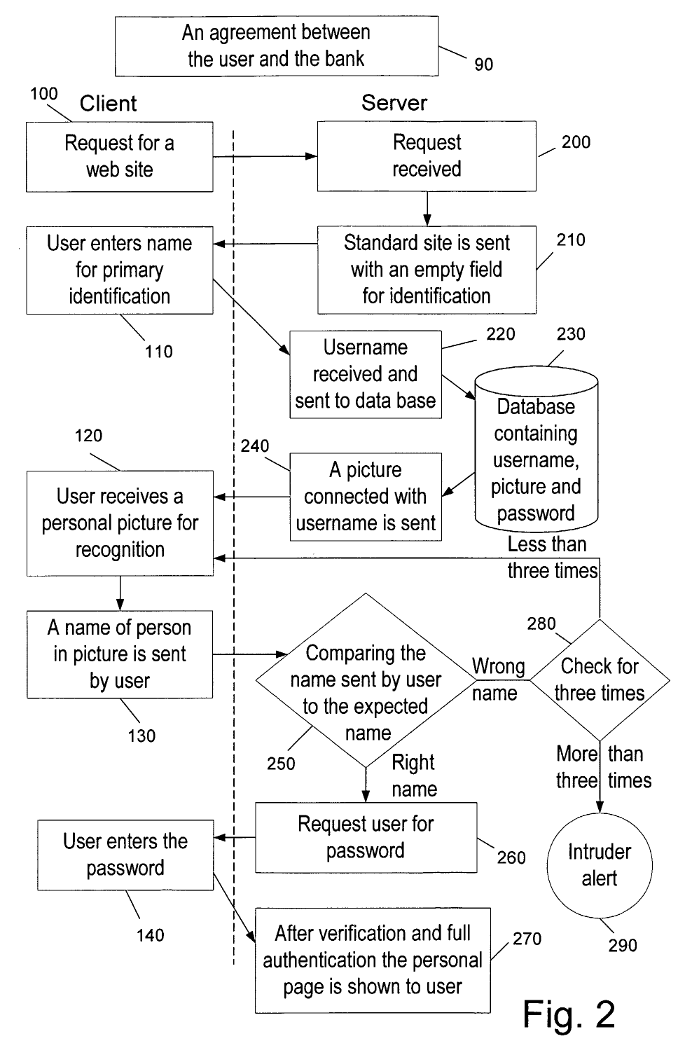

FIG. 2 is an example for an additional embodiment of the present invention. In block 90, an agreement takes place between the user and the bank concerning the way by which the user is authenticated and the bank website is authenticated. The user is given a username and a secret password, the bank receives from the user a secret personal picture, and a name of the person appearing in the picture. The username, password, picture, and the name of the person in the picture are stored in database 230. The process starts in block 100, when the user requests the bank website by typing the bank website address. In block 200 the request is received and in block 210 the first page of the site is sent to the user with an empty field for identification. In block 110 the user receives the first page of the bank site with the empty field and he enters the first client key, i.e., his username. In block 220 the website receives the username and accesses database 230. As stated before, the database 230 contains the secret picture and password associated with each username, thus in block 240 the picture that is extracted from the database, and is associated with the username is sent to the user. In block 120 the user receives the picture and verifies whether this is indeed the picture that he gave to the bank in the agreement 90. In the affirmative case, he knows that this is the real, authentic bank site, as only the real bank site can send this picture, otherwise he can conclude that the site is faked. In block 130 the user sends the name of the person depicted in the picture. In block 250 the name received is compared with the expected name stored in database 230. If the received name is different from the expected name, the user receives a message to try again as shown in block 120. If the user enters the wrong name more than three times, as shown in block 280, an intruder alert is activated in block 290 for notifying the system. If the user name to the picture is identical to the name stored in the database a request for a password is sent to the user as shown in block 260. In block 140 the user sends his password to the server. In block 270 the password is verified by comparing it to the one stored in database 230. Once the verification process has been completed the user is allowed to enter the personal page.

In a third example, a pre-agreement takes place between the user and the site owner. The user is given at least one personal key, a username, whereas the site owner receives one code for authentication, a picture from the user. The client requests display of the website by typing the website address. The server responds and sends a challenge to the client requesting the user key, a username. The client responds by entering the username. The server receives the username identifying the client, compares the username with its users database, and responds by sending to the client the site authentication code, the pre-agreed picture, associated with that specific client. The client receives the picture, and by recognizing the picture the client knows that he is in the real website.

As may be understood by a person skilled in the art the means for website authentication may verify from a picture to a personal question or any other means agreed by both sides. Furthermore, the database may hold a number of pictures or authentication means for each user. Some of the authentication means may comprise software means and/or hardware means combined together for better authentication.

As demonstrated, the present invention provides to the user means for verifying whether the web site he is accessing is authentic or fake. If the user finds by means of the method of the invention that the site is authentic, and that this is indeed the site he wishes to access, he may continue by providing to the site his secret codes. If the user concludes that the site is faked, the user will not be vulnerable to the danger of exposing his secret codes to a faked site.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for authentication of a website comprising the steps of:
a. Establishing an agreement between a user and a website owner where the user receives at least one personal client key and the website owner receives at least one personal authenticating website code;
b. Performing initial access to the website by the user;
c. Performing by the website challenge of the user for his client key;
d. Submitting by the user his client key and sending to the website;
e. Verifying at the web site said client key;
f. Sending by the website to the user the said agreed personal authenticating website code associated with that user; and
g. Verifying by the user that this is indeed the authentic website code as agreed between him and the website owner.

2. A method according to claim 1, further comprising the steps of:
h. Further establishing in said agreement between user and website owner second personal client key;
i. Challenging by the website the user for said second client key after sending said authenticating website code;
j. Submitting said second client key by user to the website.

3. A method according to claim 1, wherein the user first client key is a username.

4. A method according to claim 1, wherein the authenticating website code is a picture.

5. A method according to claim 1, wherein the authenticating website code is a hardware indication.

6. A method according to claim 1, wherein the authenticating website code is a personal question.

7. A method according to claim 1, wherein the challenging for a second client key is a request to reply to the authenticating website code.

8. A method according to claim 1, wherein the request for the second client key is a request for password.

9. A method according to claim 1, wherein the second client key is a password.

10. A method according to claim 7, wherein there is another request for a password after the request to reply to the personal code.

11. A method according to claim 1, wherein the first client key and/or second client key of the user are submitted automatically by the user side with or without human intervention.
